(19) United States
(12) Patent Application Publication
(10) Pub. No.: US 2007/0220857 A1
(43) Pub. Date: Sep. 27, 2007

(54) Mechanical leaf raking and bagging device

(76) Inventor: R. Douglas Derby, Euless, TX (US)

Correspondence Address: R. Douglas Derby, 307 Wilshire Dr., Euless, TX, 76040, US

(21) Appl. No.: 11/256,781

(22) Filed: Oct. 24, 2005

(51) Int. Cl. A01D 7/00

(52) U.S. Cl. 56/400.01

(57) ABSTRACT

A wheeled machine that rakes lawns and other surfaces to remove leaves, pine needles and other lightweight debris and conveys this material directly into a standard size plastic bag for disposal or transport to a composting location.

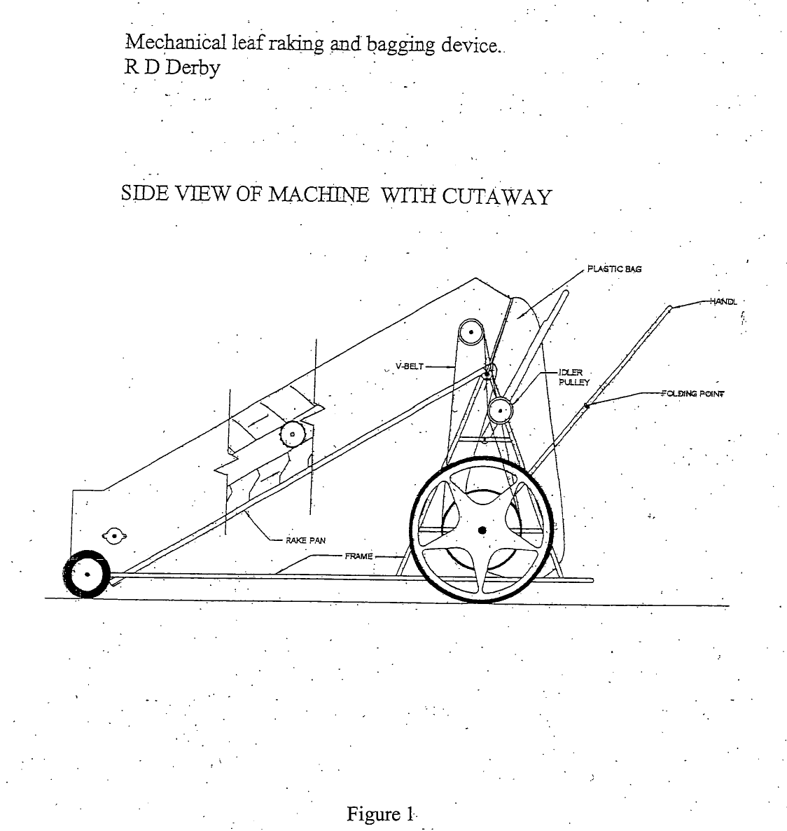

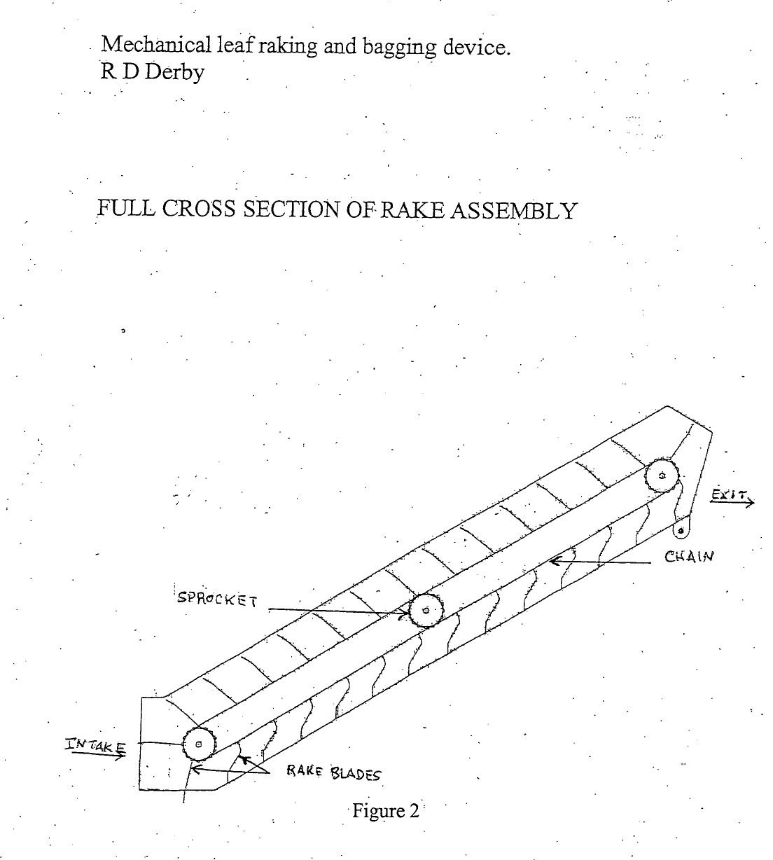

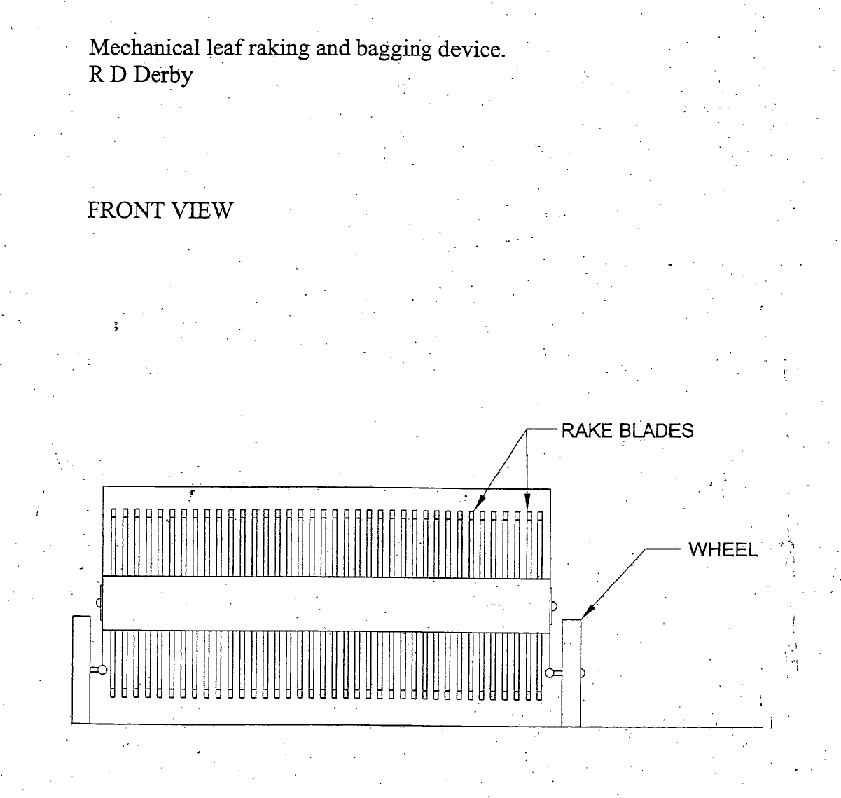

The frame is U-shaped with the two sides being approximately twice as long as the width between them. Two p airs of wheels are independently mounted on spindles located close to an d protruding outward from the four corners. The front is defined as the open end of the frame. The frame is made of lightweight metal or composite material. The front wheels are mounted on pivotal spindles with detents that provide the capability, similar to most power lawn mowers, to adjust their position upward or downward relative to the frame. Such movement has the effect of raising or lowering the front of the frame, which, in turn, moves the rake blades higher or lower relative to the ground to achieve the desired effect. The rear wheels are approximately twice the radial size of the front ones. They are mounted on spindles protruding from a pair of vertical supports, which are rigidly attached in an upright manner to the rear quadrants of the U-frame on opposite sides of the frame. The spindles are positioned to achieve the desired ground clearance for the U-frame.

The rake assembly consists of a continuous loop of hinged interlocking components, which are mounted on two or more sets of sprockets. Cog wheels could also be utilized. Each set of sprockets (3 or more) is evenly spaced on an axle, which is longer than the width of the assembly. The configuration is similar to the track of a bulldozer. The rake assembly is approximately 2 feet wide with parallel rows of rake blades which are evenly spaced and of equal length (approximately 4 inches) mounted laterally across the width of the assembly and protruding slightly less than perpendicular to the direction of travel. The blades are similar t o those of common hand rakes and can be made of metal or composite material either of which must have rigidity and flexibility similar to a common hand held metal leaf rake. This assembly is mounted on two or more parallel sets of sprockets. The number of sprockets required depends on the width of the assembly. Each of the interlocking components of the assembly has holes which match the points of the sprockets. When an axle is rotated the assembly travels over the sprockets and the blades provide the raking action. The rake assembly is housed in a rectangular box with open ends. The center shafts (axles) of the sprockets provide the means of support for the entire assembly. They extend through the sides of the housing into flange bearings attached to the outside. This housing is mounted on the frame in a tilted position so that the front portion allows the rake blades to extend through the open end and engage the lawn surface in similar fashion as when using a conventional hand rake. The rear end of the housing is supported by the rear axle protruding thru it and thru holes in the upper portion of the vertical supports of the frame above the rear wheels. The raised rear opening provides an exit point for the raked material directly into a lawn bag (paper or plastic) that is attached to the upper and lower edges of the rear opening by spring clamps. This exit height and opening size are sufficient to permit usage of standard size plastic lawn and leaf bags. The bottom of the bag is supported by a flat platform attached across the U-frame between the rear wheels.

Attached to the inside of one of the rear wheels is a V-belt pulley that is smaller in diameter than the wheel and rests on the same spindle. A V-belt connects it to a smaller pulley, which is mounted on the center shaft (axle) of the rear sprocket set of the rake assembly. The axle protrudes past the flange bearing sufficiently to accommodate the mounting of the pulley. The pulley assembly could be replaced by bicycle type sprockets and chain or other similar drive mechanism and, either front or middle or rear axle of the assembly could be used as the drive axle. When the machine is pushed forward or the wheel is turned the turning action to operate the internal moving parts is provided. The relative diameters of the V-belt pulleys determine the speed of the rake assembly movement. This motion is always faster than, and directly proportional to the travel rate of the entire machine. Under normal operation the rake blades travel across the lawn surface in the opposite direction of the movement of the entire machine.

Propulsion is accomplished in one of several ways. Hand pushing is the method herein referred to, but electric or gasoline powered motors could be utilized to provide machine and/or rake assembly movement.

The bottom, or pan, of the rake assembly housing is parallel to the rake assembly and close enough to it that the rake blades are pressed against it with sufficient tension to hold the leaves or debris in place until reaching the top lip, or rear end, of the pan. At this point the tension on the rake blades is released and the raked material is thrown into the attached bag with force sufficient to ensure that the material is evenly distributed and the bag can be completely filled.

The parallel rows of rake blades are spaced a few inches apart. This distance and the length (or height) of the blades could be varied for special applications without affecting the unique functionality of the design. Each row of blades engages the surface briefly and moves loose material a short distance toward the rear of the machine, which is moving forward. The rows of blades, with any debris captured, meet the leading edge of the bottom of the rake assembly housing and are depressed against it while traveling to the rear opening of the housing. This mechanically duplicates the action of extending a hand held rake over a section of lawn and drawing it toward the operator to any device, such as a common dust pan, which can be depressed against the rake to hold the captured debris until it can be deposited elsewhere. i.e. a plastic bag.

As the rake blade assembly travels around the rear sprockets the blades pass between rigid tines or fins that are mounted on the under side of the top cover. This removes any residual material, which falls into the bag, and prevents it from making a return trip to the front. The topside of the housing is high enough above the rake assembly to insure that the rake blades do not touch it.

A movable V-belt idler pulley located on the side of the machine allows the operator to engage or disengage the rake assembly as desired by moving the idler so that the belt is either taut or loose. This allows the operator to push the machine without incurring any raking action.

The upper V-belt pulley that is mounted on the axle of the sprocket set is press fitted with a clutch bearing so that when the machine is propelled backward the drive pulley turns freely on the shaft. Thus, the rake assembly remains in position and does not eject the leaves that are in transit from lawn to bag. This enables the operator to stop, back up and change directions without losing any raked material or damaging any of the machine components.

The moveable idler pulley and clutch bearing provide two important additional capabilities: stationary operation and reverse rake assembly action. These functions are accomplished by manual operation of the rake assembly. The machine is equipped with a hand crank that can be attached to the end of the drive sprocket shaft which extends through the upper pulley. Disengaging the V-belt tension and using the hand crank allows the operator to propel the rake assembly forward while the machine remains in one place. This enables the collection of leaves accumulated in a location that the machine cannot pass over or through, such as a corner of a fenced yard. The hand crank also provides the operator a way to reverse the travel direction of the rake assembly in case of a jam.

The push handle is U-shaped with the open end attached to the rear sides of the frame so that the closed end is positioned behind and slightly above the rear end of the rake assembly housing. The appearance is very similar to that of a common power lawn mower. The handle is jointed at approximately the halfway length of each side. This enables the operator to fold the rear half of the handle upward and forward so that the bag and the clamps that hold it in place are easily accessible for removal and replacement.

### BACKGROUND OF THE INVENTION

According to an article in the U.S. News & World Report, Oct. 11, 2004 edition, “Americans rake up at least 200 million lawn bagfuls of leaves each year, straining countless backs in the process.” The problem of collecting leaves, pine needles and other lightweight debris is an annual, and in some cases ongoing, fact of life for many people. The need for a fast simple method of picking up lawn debris is well recognized by those who want to maintain the outside appearance of their dwelling. Consequently, numerous devices have been conceived to address the problem. Most devices are handy tools that assist with a part of the task i.e., there are several inventions that provide a means of gathering leaves and some that hold a bag open, but none that perform both tasks as efficiently as my mine. My machine is lightweight, sturdy and highly maneuverable. It will assist many people to accomplish the job faster and easier.

There exists some valid criticism of putting space-hogging bags of leaves into our landfills but the alternatives are inadequate. Composting is a great idea but the volume of leaves far exceeds the space available for, and the amount of compost needs of, the average household. Mulching grass clippings and leaves is another alternative with limitations. Too much mulch becomes thatch, which sheds water and blocks sunlight and can cause lawns to be thin and mushy. A better idea, which is gaining popularity, is to capture the leaves into strong biodegradable paper bags. Using my machine to fill such bags is an excellent solution to the problem.

### SUMMARY

A mechanical leaf raking and bagging device.

The machine provides a faster and easier method of collecting yard debris than is currently in existence. This recurring task is accomplished by the machine's unique combination of functions which are found separately in other products.

### DESCRIPTION OF DRAWINGS

1. A side view of the assembled machine

2. A side view of the rake blade assembly inside the housing

3. A view of the front opening of the device showing rows of rake blades

### PRIOR ART

Research of previous patents reveals numerous products that address the need for an easier way to remove debris from a lawn.

U.S. Pat. No. 5,743,076 Kim Kwee Ng Apr. 28, 1998 56/400.02

This device uses spikes to pierce debris but does not collect into a bag.

U.S. Pat. No. 5,593,117 Wilson Dec. 17, 1996 172/41

This attaches to another device for power, does not deposit directly into a bag.

U.S. Pat. No. 5,509,259 T. Milbury Aug. 9, 1994 56/400.04

This machine collects but does not bag debris.

U.S. Pat. No. 5,375,399 Kraft Mar. 15, 1993 56/16.7

This is a powered device for de-thatching a lawn. It does not collect into a bag.

U.S. Pat. No. 5,564,267 Bricker, et al Oct. 15, 1996 56/400

This is a sophisticated hand tool. It is a combination rake and shovel, doesn't mechanically collect or bag.

U.S. Pat. No. 5,509,259 Thomas Milbury Apr. 23, 1996 56/400.04

Collects lawn debris mechanically but into a hopper, which has to be manually transferred to a bag or other area.

U.S. Pat. No. 5,121,592 Jetson, John T. Jun. 16, 1992 56/344

Collects into a chamber, which must be emptied into another conveyance.

U.S. Pat. No. 5,000, 406 Peterson Mar. 19, 1991 56/344

This gasoline engine powered device also collects into a hopper which then is emptied eleswhere.

U.S. Pat. No. 4,217,672 Humbert, Olivari Feb. 4, 1980 15/79.1

This is a revision of U.S. Pat. No. 4,297,760 and does seem to perform the same functions of my machine. However, my machine is different in several ways. Mine is 4 wheeled vs. 2 and has the capability to be moved backward without the raking function also moving in reverse, which means debris would not be discharged. Mine also has provision for operating from a stationary position and provides means for the operator to reverse the internal mechanism to remove any jammed debris. My device also provides operator adjustable raking action for different height or type of lawn grasses. Mr. Olivari's device does not have these operational efficiencies.

1. A wheeled device that, when propelled forward, collects leaves, pine needles and other lightweight debris from lawns and other surfaces directly into an attached bag, and which is comprised of;
(a) a framework that is supported above, and approximately parallel to, the ground by two pair of wheels.
(b) a rectangular boxlike housing with open ends attached to said framework in a tilted manner so that the front end of the housing is near ground level and well below the rear end,
(c) a handle is attached to both sides of the device across the rear of the device to facilitate pushing and maneuvering the device,

2. A wheeled device of claim 1 with an assembly of interlocking components that form a wide continuous flexible belt like apparatus with rake blades protruding approximately perpendicularly from the surface in evenly spaced rows across the width of it,
